(19) United States
(12) Patent Application Publication
(10) Pub. No.: US 2013/0062970 A1
(43) Pub. Date: Mar. 14, 2013

(54) SWITCHING DEVICE

(71) Applicants: Reinhard Maier, Herzogenaurach (DE); Sebastian Nielebock, Baiersdorf (DE)

(72) Inventors: Reinhard Maier, Herzogenaurach (DE); Sebastian Nielebock, Baiersdorf (DE)

(21) Appl. No.: 13/697,989

(22) PCT Filed: May 9, 2011
(86) PCT No.: PCT/EP2011/057405

§ 371 Date: Nov. 14, 2012

(30) Foreign Application Priority Data
May 14, 2010 (DE) 10 2010 020 609.1

(51) Int. Cl. H01H 47/00

(52) U.S. Cl. 307/130

(57) ABSTRACT

A phase changeover switch selects that phase of a three-phase supply system which has the lowest loading for forwarding to a single-phase connection.

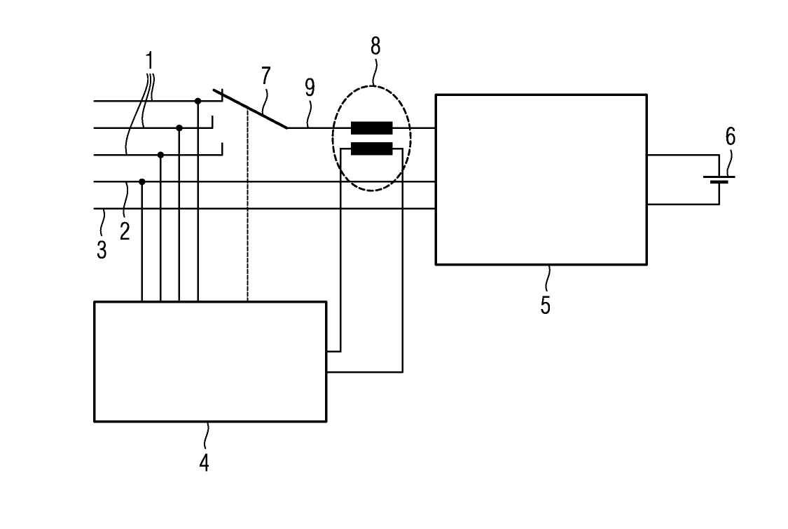

### CROSS REFERENCE TO RELATED APPLICATIONS

This application is the U.S. national stage of International Application No. PCT/EP2011/057405, filed May 9, 2011 and claims the benefit thereof. The International Application claims the benefits of German Application No. 102010020609.1 filed on May 14, 2010, both applications are incorporated by reference herein in their entirety.

### BACKGROUND

Described below is a switching device for intermediate switching between a three-phase supply system and a single-phase connection, such as e.g. a power socket.

In the near future, the energy storage devices of electric vehicles will, in many cases, be charged from low-voltage systems. In the light of the large quantity of energy which must be stored in the vehicle within a short space of time, the use of charging devices with a very high connection rating must be anticipated. In consequence, there will be a very substantial increase in the loading of the low-voltage system, in comparison with existing conditions.

One measure for system loading is the voltage drop across system impedances, which results in a reduced voltage at the input of the charging device in relation to the no-load voltage. In case of asymmetrical system loading, e.g. associated with a single-phase charging device, variations in voltage drop will also result in an asymmetrical connection voltage on the three phases of the supply system.

### SUMMARY

An aspect is the disclosure of a switching device which reduces the problem described above. Specifically, the switching device will enable a reduction in the loading of the supply system. Specifically, reduced loading, by way of a reduction in asymmetric loading, will be achieved during the charging of an electric vehicle using a single-phase charging device.

The switching device includes:

a three-phase connection to a supply system,
connection to lines for the single-phase transmission of voltage,
an apparatus determining the phase voltage on at least one of the three phases, and
switching equipment for the connection of the lines for the single-phase transmission of voltage to one of the three phases.

In developing the switching device, it has been recognized that single-phase charging devices, specifically for use with electric vehicles, might, in the case of the more widespread use of the latter, result in the substantial asymmetric loading of the supply system. The switching device may be provided between a connection, e.g. a power socket, and the three-phase supply system. The switching device determines the phase voltage on at least one of the three phases of the supply system. It is expedient when the voltage on all three phases is determined. It is also expedient when the highest of the three phase voltages is determined. The phase with the highest voltage is the phase with the lowest loading. The switching equipment may connect the determined phase with the highest voltage to the lines for the single-phase transmission of voltage. In simple terms, for example, the phase with the highest voltage is routed to the power socket.

It is advantageous when, during the charging e.g. of an electric vehicle, but also of other energy storage devices, such as private domestic power storage devices, communication is possible between the charging device or energy storage device and the switching device. To this end, the switching device may be provided with a communication system for the purposes of communication with a device which is connected to the lines for the single-phase transmission of voltage. The communication system is designed such that no changeover is effected by the switching equipment in response to signals from the device. In other words, by communication with the connected device, e.g. the energy storage device or charging device, it can be ensured that no changeover of the routed phase is effected by the switching device during the charging process. By this arrangement, a distinction may advantageously be drawn between consumers for which an in-service phase changeover has no adverse effects, and those for which an in-service phase changeover should not take place.

If the connected device is not provided with any corresponding communication system or where, for other reasons, the communication and control function described is not possible, the switching device may be advantageously perform measurement of the current in the lines for the single-phase transmission of voltage. These may be configured e.g. in the form of current transducers. By this arrangement, independently of the device, the switching device can detect the existence, at present, of any load demand on the lines for the single-phase transmission of voltage. At such times, the switching device can then automatically avoid any phase switchover, independently of any external influence.

An electrical consumer is also disclosed, specifically a charging device for the charging of an electrical energy storage device with:

a single-phase connection to a supply system, and
a communication system for communication with a switching device.

The communication system is designed to deliver signals to the switching device, which can be interpreted by the latter such that the switching device can either refrain from or effect a changeover between different phases of the supply system.

The switching device may both be designed to provide a current measurement function and have a communication system.

In other words, both of the options described may be combined.

### BRIEF DESCRIPTION OF THE DRAWINGS

These and other aspects and advantages will become more apparent and more readily appreciated from the following description of the exemplary embodiments, taken in conjunction with the accompanying drawing.

The drawing is a schematic representation of a switching device arranged between a single-phase charging device and the supply system.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

A supply system is has three phase lines 1, a neutral conductor 2 and a ground conductor 3. A charging device 5 for an electric vehicle is connected to a power socket (not represented), and is thereby indirectly connected to the supply system. The charging device 5 charges the vehicle battery 6.

The neutral conductor 2 and the ground conductor 3 are directly interconnected with the power socket, and consequently also with the charging device 5. However, a switching device is provided between the phase lines 1 of the supply system and the single phase line 9 of the power socket, the switching device having a measuring and monitoring device 4, a switch 7 and a current transducer 8.

In this exemplary embodiment, it is assumed that there is no facility for communication between the charging device 5 and the measuring and monitoring device 4. Accordingly, the measuring and monitoring device 4 uses the current transducer 8 to determine whether the charging device 5 or any other connected device is in service, thereby resulting in a flow of current. To this end, the current flow, or a mean or r.m.s. value for the latter, is compared with a threshold value. This threshold value is definable. For example, it may be defined to permit a distinction between charging devices for electric vehicles, or similar devices operating at the upper capacity limit for single-phase lines, and other consumers of lower capacity. It can also be defined such that, below this threshold, there is virtually no current flow, in other words, values below this threshold will only occur where the load demand is virtually zero.

Where the current flow falls below the definable threshold, the measuring and monitoring device 4 identifies the phase line 1 with the highest voltage. The mean or r.m.s. value is expediently considered for this purpose. Where this value is identified, the switch 7 will be actuated such that the phase identified, i.e. the phase with the highest voltage, and consequently the lowest loading, is interconnected with the power socket. In other words, the charging device, or any other device which is connected to the power socket, is automatically routed back to the phase line 1 which, at the time of the most recent measurement by the measuring and monitoring device 4 was carrying the highest voltage.

For the purposes of both current measurement and voltage measurement, it is appropriate, in the light of the alternating voltage involved, that a sufficient time interval should be allowed for the measurement of the average value. In other words, the measuring and monitoring device 4 should not respond immediately in case of an (apparent) change in conditions, but only upon the expiry of e.g. 1 second or, in other examples, 5 seconds, 10 seconds or 100 ms.

In another example (not represented), the charging device 5 is provided with a communication system. In the present example, this system is configured in the form of the separately known “Power Line Communication” (or PLC) interface. This interface is used for the feedback of a signal into the network and to the measuring and monitoring device 4 when the charging device is actually engaged in a charging procedure. The signal is received and interpreted by the measuring and monitoring device 4. Where the measuring and monitoring device 4 receives a correspondingly formulated signal from the charging device 5, no further changeover of the phase line 1 will consequently occur.

This condition may persist e.g. until the charging device 5 transmits a corresponding signal, to the effect that a further changeover may proceed. The measuring and monitoring device 4 may be appropriately provided with a further option for the resumption of changeover operations. For example, after a time interval of e.g. 1 minute, or in particular 10 seconds, in the absence of any current flow to the power socket, the measuring and monitoring device 4 may assume that a changeover is again possible. To this end, the measuring and monitoring device 4 in this second example is also provided with the current transducer 8.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-6. (canceled)

7. A switching device, comprising:
a three-phase connection to a supply system;
a connection to lines for single-phase transmission of voltage;
means for determining a phase voltage on at least one of three phases of the supply system; and
switching equipment connecting the lines for the single-phase transmission of voltage to one of the three phases.

8. The switching device as claimed in claim 7, further comprising means for measurement of the current on the lines for the single-phase transmission of voltage.

9. The switching device as claimed in claim 8, wherein the means for the measurement of the current are configured as a current transducer.

10. The switching device as claimed in claim 9,
wherein said determining means determines the phase voltage that is highest; and
wherein said switching equipment connects the determined phase to the lines for the single-phase transmission of voltage.

11. The switching device as claimed in claim 10, wherein a device is connected to the lines for the single-phase transmission of voltage, and
further comprising a communication system providing communication with the device and effecting no changeover by the switching equipment in response to signals from the device.

12. An electricity consuming device in communication with a switching device providing a single-phase transmission of voltage from one of three phases of a supply system after determining a phase voltage on at least one of three phases of the supply system, comprising:
a single-phase connection to the supply system via the switching device; and
a communication system delivering signals to the switching device which either prevent or permit a changeover between different phases on the supply system.
